(19) United States
(12) Patent Application Publication
(10) Pub. No.: US 2007/0114748 A1
(43) Pub. Date: May 24, 2007

(54) Rear axle of a motor vehicle with an independent wheel suspension

(75) Inventors: Ludwig Seethaler, Hebertshausen (DE); Alfred Stenzenberger, Fuenfstetten (DE); Jan Eilers, Planegg (DE); Klaus Trzaska, Friedberg (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/655,140

(22) Filed: Jan. 19, 2007

Related U.S. Application Data
(63) Continuation of application No. PCT/EP05/06965, filed on Jun. 29, 2005.

(30) Foreign Application Priority Data
Jul. 21, 2004 (DE) 10 2004 035 320.4

(51) Int. Cl. B60G 3/20; B60G 7/00

(52) U.S. Cl. 280/124.135; 280/124.134

(57) ABSTRACT

A rear axle of a two-track motor vehicle is provided. The vehicle may have an independent wheel suspension with lower rods, which guide a wheel carrier, and an upper guide device, which engages with an extension arm of the wheel carrier. The extension arm guides in a region above a wheel mounted on the wheel carrier. The upper guide device is formed by a physical guiding path comprising a guide element, which can be displaced along said guiding path.

### CROSS REFERENCE TO RELATED APPLICATIONS

This application is a continuation of PCT International Application No. PCT/EP2005/006965, filed Jun. 29, 2005, which claims priority under 35 U.S.C. § 119 to German Patent Application No. 10 2004 035 320.4, filed Jul. 21, 2004, the entire disclosures of which are herein expressly incorporated by reference.

### BACKGROUND AND SUMMARY OF THE INVENTION

The present invention relates generally to motor vehicles and, more particularly, to a rear axle assembly of a two-track motor vehicle with an independent wheel suspension.

With respect to the technological environment, reference is made to non-prior published German patent application 103 55 198, and also to DE 199 03 435 A1 and DE 195 24 106 A1.

In motor vehicles that attempt to meet high demands on driving dynamics and driving comfort, double wishbone axles and their variants have prevailed, since they offer favorable conditions for kinematic and elastokinematic fine tuning. In such vehicles, the rear axles typically exhibit a carrier spring assembly and a damper arrangement next to the wheel, either from the wheel carrier directly to the vehicle superstructure or from a transverse link to the superstructure. A so-called rear axle carrier is also typical, which in turn is connected to the vehicle superstructure for the purpose of acoustical uncoupling and for the purpose of achieving a good longitudinal suspension over large volume rubber bearings of the rear axle carrier. In this conventional rear axle design, the so-called spring leg is located relatively high next to the wheel envelope crown and, hence, has a negative impact on the maximum loading width of the trunk, provided in this region of the vehicle superstructure.

In order to create more interior space (for example, loading width in the trunk) in a motor vehicle in the region of the rear axle, one could provide in principle a wheel suspension with a so-called extension arm of the wheel carrier, which extends into a region essentially above the wheel and engages with the upper guide device for the wheel. According to the system disclosed in DE 195 24 106 A1, such an upper guide device is constructed as a leaf spring and, therefore, assumes simultaneously the function of the carrier spring between the vehicle body and the wheel. However, this conventional arrangement cannot satisfy the high demands with respect to suspension comfort, driving comfort and driving dynamics.

In non-prior published German Patent application 103 55 198, a carrier spring is constructed as a helical spring or a pneumatic spring, by which the so-called extension arm of the wheel carrier is disposed approximately above the wheel center. Furthermore, this extension arm is guided by means of one or two upper transverse links, which extend essentially in the transverse direction of the vehicle.

An aspect of the present invention is to provide a rear axle, which meets in the best possible way the high demands with respect to suspension comfort, driving comfort and driving dynamics. Consistent with the present invention, a rear axle assembly for a two-track motor vehicle may be provided. The motor vehicle may be a two-track motor vehicle with an independent wheel suspension with lower rods, which guide a wheel carrier, and an upper guide device, which engages with an extension arm of the wheel carrier, the extension arm guiding in a region essentially above a wheel mounted on the wheel carrier. The upper guide device may be formed by a physical guiding path comprising a guide element, which can be displaced along said guiding path.

Given that upper transverse links limit the space between the vehicle wheels available for interior space, the shortest possible transverse links are preferred. The links in turn should not drop below a defined minimum length so that the required kinematic and elastokinematic properties of the wheel suspension may be realized. Consistent with the present invention, the so-called upper guide device may be constructed in the form of a physical guiding path that is equivalent kinematically to transverse links. That is, it is constructed not in the form of a virtual guiding path that is defined by transverse links, but rather in the form of a mechanical guiding path. A so-called guide element may be guided along the path in an optimal manner. In this respect, the guide element may be fastened to and/or supported directly or indirectly on the extension arm of the wheel carrier, whereas the “mechanical” physical guiding path may be fastened to or supported directly or indirectly on the body and/or on the superstructure of the motor vehicle. Of course, the kinematic inverse thereof is also possible.

The so-called guide geometry of the guiding path (in interaction with the guide element) may be based on the respective kinematic requirements. In the simplest case, a linear guide along a straight line may be sufficient. In the event of higher kinematic demands, however, a curved guiding path having a constant radius and in the general case a spatially (therefore, about three axes) curved path having variable radii are also possible. The physical guiding path may be constructed as a rod that is shaped in conformity with said guiding path and exhibits, for example, a circular cross section, on which a guide element, which may or may not have the shape of a sleeve, is guided so as to slide along the rod axis. Different ways of mounting the guide element on the guiding path are possible even as a function of the respective guide geometry. Sleeve-shaped sliding bearings or commercially available linear bearing arrangements may be suitable. Other sliding or roller bearings or even more complicated ball recirculation mechanisms for spatially curved guiding paths are also suitable. If necessary, a combination of a ball and socket joint or a rubber bearing, which realizes a cardanic degree of freedom, is also possible. Moreover, a rubber bearing may also assume other functions, like an acoustic uncoupling and longitudinal suspension.

Other objects, advantages and novel features of the present invention will become apparent from the following detailed description of the invention when considered in conjunction with the accompanying drawings.

### BRIEF DESCRIPTION OF THE DRAWING

FIG. 1 is a three dimensional simplified drawing of the left rear wheel of a motor vehicle with an independent wheel suspension, consistent with the present invention.

### DETAILED DESCRIPTION OF THE DRAWING

The following description refers to the accompanying drawing. The implementations set forth in the following description do not represent all implementations consistent with the claimed invention. Instead, they are merely some examples of implementations consistent with the invention. Other implementations may be used and structural and procedural changes may be made without departing from the scope of present invention.

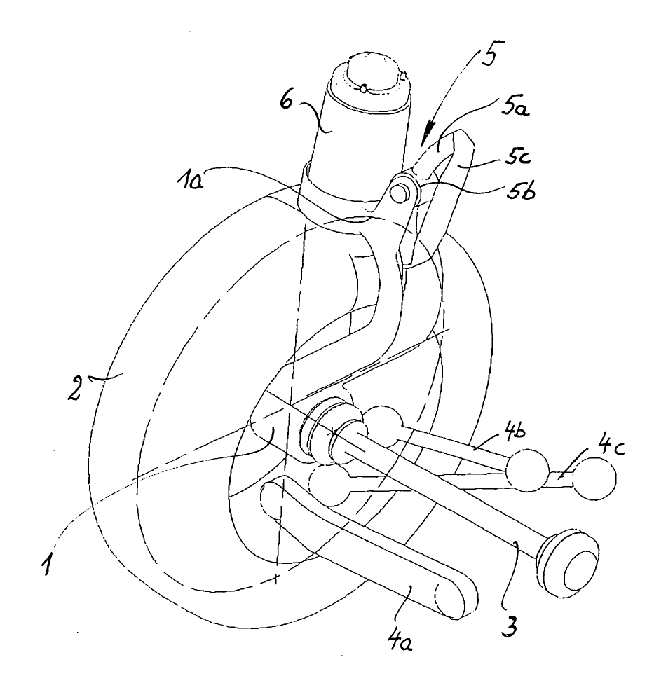

Reference is now made to FIG. 1, which is a three dimensional simplified drawing of the left rear wheel of a motor vehicle with an independent wheel suspension, consistent with the present invention. In this drawing, reference numeral 1 refers to a wheel carrier; and the reference numeral 2 refers to a wheel, mounted on said wheel carrier. A driven shaft 3 serves to drive this wheel 2.

The wheel 2 and/or its wheel carrier 1 is/are guided by three lower rods 4a, 4b, 4c, of which two extend at least in essence in the transverse direction of the vehicle. The wheel carrier 1 continues to be guided in a so-called upper guide device 5, which engages with an extension arm 1a of the wheel carrier, which projects into a region essentially above the wheel 2. On its end facing the wheel carrier 1, this extension arm 1a is provided with a recess for a carrier spring element 6, by means of which the vehicle superstructure or rather the body (not illustrated) of the motor vehicle is ultimately supported on the wheel 2. The extension arm la and its accommodation for a carrier spring element 6 are formed in such a manner that the carrier spring element 6 is located in essence directly over the wheel center above the wheel 2.

The upper guide device 5 comprises a physical guiding path 5a, on which a so-called guide element 5b, which exhibits the shape of a sleeve in this case, can be slid in the longitudinal direction. The geometry of the guiding path 5a may be linear or curved with a constant or variable curvature or radii, extending along the guiding path. The physical guiding path 5a may be constructed as a rod that is shaped in conformity with said guiding path.

While the guide element 5b is fastened on the extension arm 1a of the wheel carrier 1 in a region above the wheel 2, the guiding path 5a is fastened in a way (not illustrated in detail) on the body (also not illustrated) of the motor vehicle by way of a retaining bracket 5c, which engages with the ends of said guiding path.

Although, in this simplified representation, the carrier spring element 6 is fastened on the so-called extension arm 1a above the wheel 2, the present invention is not limited to such an arrangement of the carrier spring element. Rather, an embodiment with a carrier spring that is located at the bottom is conceivable. In this case, the wheel carrier-sided extension arm 1a to the guiding path 5a, which is located at the top, is relieved of the spring forces (and then usually also of the damper forces). The result is that the extension arm 1a can be dimensioned inexpensively and optimally with respect to weight. Even for a front driven motor vehicle without a driven shaft 3, a compact design and a generous offer of interior space can still be realized, for example, with a transverse link-fixed arrangement (that is, on one of the transverse links 4a, 4b) of the carrier spring, optionally also of the damper.

With the embodiment illustrated in FIG. 1, the guide device may have a linear guiding path comprising a spiral-shaped groove or the like—called an adjusting groove here—almost as an intermediate step on the way from a linear to a three dimensional guide. The sleeve-shaped guide element interacts with said groove in such a manner (e.g., by means of an adjusting spring) that during a suspension movement (i.e., when moving along the guiding path) this guide element is also put into rotational motion about the vertical axis. This rotation or another additional movement may also be utilized to produce a transverse movement of the wheel carrier. This movement of the wheel carrier corresponds to an increase in the negative camber during compression, by an eccentricity between the axis of the guiding path and the axis of the guide element. Thus, the wheel carrier is guided in a spatially curved manner, even though the guiding path itself does not exhibit any curvature. This feature has a beneficial impact on the production of and the mounting on and/or in the so-called upper guide device.

Moreover, the comparatively low force level that prevails at the distance from the wheel contact point leads to significantly lower bearing forces than on the lower transverse link plane and is useful for realizing a three dimensional guide. Because of this low force, it is possible to dispose the guiding path in the middle above the wheel. It is also possible to offset the guiding path in the longitudinal direction of the vehicle either in front of or behind the carrier spring element, which is positioned optionally in essence above the center of the wheel.

The carrier spring element may be constructed as a steel helical spring or a pneumatic spring. For a more or less concentric arrangement of the carrier spring element and the guiding path, it is advantageous to provide a pneumatic spring. The pneumatic spring may effect at the same time in an advantageous manner a protective and sealing function for the moveable elements of the upper guide device, if these moveable elements are disposed inside the pneumatic spring and/or inside its bellows. Then the upper spring washer and the body-sided arrangement of the guiding path may be designed as an integral component.

A very compact design is achieved when not only the carrier spring element and the so-called upper guide device are arranged in a concentric manner, but also when the damping function is realized inside the space of the carrier spring element, constructed as a pneumatic spring. To this end, the pneumatic spring volume may be divided by a diaphragm. This diaphragm may be provided with valves so that during suspension movement the throttling losses of the air flowing through to the valves can be used as the damping means. Therefore, an interior, characterized by its maximum utility, no longer exhibits any components (i.e., there is no link, no carrier spring and no damper) above the driven shaft as far as up to the wheel envelope crest.

Furthermore, due to the low force level and the compact design, an active camber control in conjunction with the proposed guiding path can be easily realized on the rear axle, consistent with the present invention. In this case, the guiding path may not be carried out so as to be fastened directly on the body, but rather may be designed so as to slide linearly in essence in the transverse direction of the vehicle by means of, for example, electric or hydraulic actuators.

The proposed design of a wheel suspension, in particular a driven wheel suspension, enables the fulfillment of high demands on the driving comfort and the driving dynamics in connection with an above average generous offer of interior space between the rear wheels. Therefore, due to the three dimensional guidance of the wheel carrier on a guiding path, the high kinematic and elastokinematic potential of a double wishbone axle or a five link axle may be reached. Because of the arrangement of the carrier spring between the wheel carrier and the body, the rear axle carrier bearing remains free of initial loads, a feature that has a good effect on the acoustical transmission properties. At the same time, depending on the design, in the critical space above the driven shaft and next to the wheel envelope crown there is no longer any component of the wheel guide that restricts the useable interior space. In addition, optimal conditions are created in order to realize an active camber control without having to limit the volume of the interior space that is useable.

FIG. 1 is consistent with an exemplary implementation of the present invention. Various details that may depart from the above illustrations may be possible, without departing from the scope of the appended claims and equivalents thereof.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A rear axle assembly of a two-track motor vehicle with an independent wheel suspension with lower rods, which guide a wheel carrier, and an upper guide device, which engages with an extension arm of the wheel carrier, the extension arm guiding in a region above a wheel mounted on the wheel carrier, and a carrier spring element for a body of the vehicle being supported on the extension arm above a center of the wheel,
wherein the upper guide device is formed by a curved physical guiding path comprising a guide element, which is displaced along the curved guiding path.

2. The rear axle assembly of claim 1, wherein the physical guiding path is fastened directly or indirectly to the body of the motor vehicle, and wherein the guide element is fastened directly or indirectly to the extension arm of the wheel carrier.

3. The rear axle assembly of claim 1, wherein the physical guiding path is fastened directly or indirectly to the extension arm of the wheel carrier, and wherein the guide element is fastened directly or indirectly to the body of the motor vehicle.

4. The rear axle assembly of claim 1, wherein at least one of a sliding bearing and a roller bearing is provided between the guide element and the physical guiding path.

5. The rear axle assembly of claim 4, wherein at least one of a ball socket joint and a rubber bearing is provided between the guide element and the physical guiding path in combination with the sliding bearing or the roller bearing.

6. The rear axle assembly of claim 1, wherein the physical guiding path with the guide element is disposed inside the carrier spring element, the carrier spring element being constructed as a pneumatic spring.

7. The rear axle assembly of claim 1,
wherein a function of a damper is assumed by the carrier spring element, and
wherein the carrier spring is constructed as a pneumatic spring for performing the function, the pneumatic spring being subdivided into two volumes that are connected together by damping valves.

8. The rear axle assembly of claim 1, wherein the guide element of the guide device assigned to the body of the vehicle is supported on said body so as to be adjustable in relation to the vehicle body.

9. A system in a two-track motor vehicle having an independent suspension, the system comprising:
an upper guide device formed by a curved physical guiding path comprising a guide element that is displaced along the curved guiding path,
wherein the upper guide device engages with an extension arm of a wheel carrier, the wheel carrier being guided by lower rods of the independent suspension, and the extension arm being guided in a region above a wheel mounted on the wheel carrier; and
a carrier spring element for a body of the vehicle that is supported on the extension arm above a center of the wheel.

10. The system of claim 9, wherein the physical guiding path is fastened directly or indirectly to a body of the motor vehicle, and wherein the guide element is fastened directly or indirectly to the extension arm of the wheel carrier.

11. The system of claim 9, wherein the physical guiding path is fastened directly or indirectly to the extension arm of the wheel carrier, and wherein the guide element is fastened directly or indirectly to a body of the motor vehicle.

12. The system of claim 9, wherein at least one of a sliding bearing and a roller bearing is provided between the guide element and the physical guiding path.

13. The system of claim 12, wherein at least one of a ball socket joint and a rubber bearing is provided between the guide element and the physical guiding path in combination with the sliding bearing or the roller bearing.

14. The system of claim 9, wherein the physical guiding path with the guide element is disposed inside the carrier spring element, the carrier spring element being constructed as a pneumatic spring.

15. The system of claim 9,
wherein the carrier spring element performs a function of a damper, and
wherein the carrier spring is constructed as a pneumatic spring for performing the function, the pneumatic spring being subdivided into two volumes that are connected together by damping valves.

16. The system of claim 9, wherein the guide element is supported on a body of the vehicle so as to be adjustable in relation to the body of the vehicle.

17. A suspension system in a two-track motor vehicle, the suspension system comprising:
lower rods that guide a wheel carrier;
an upper guide device formed by a curved physical guiding path comprising a guide element that is displaced along the curved guiding path, the upper guide device engaging with an extension arm of the wheel carrier, the extension arm guiding in a region above a wheel mounted on the wheel carrier; and
a carrier spring element that is supported on the extension arm above a center of the wheel.
